(19) United States
(12) Patent Application Publication
(10) Pub. No.: US 2005/0287370 A1
(43) Pub. Date: Dec. 29, 2005

(54) Film laminate with at least one diffusion-barrier layer and its use in vacuum insulation panels in the construction sector

(75) Inventors: Dirk Kaczmarek, Achim (DE); Sven Jacobsen, Bad Fallingbostel (DE)

Correspondence Address: FOLEY AND LARDNER LLP;SUITE 500, 3000 K STREET NW, WASHINGTON, DC, 20007, US

(73) Assignee: WIPAK WALSRODE GmbH CO. & KG

(21) Appl. No.: 11/152,854

(22) Filed: Jun. 15, 2005

(30) Foreign Application Priority Data
Jun. 16, 2004 (DE) 10 2004 028 756.2

(51) Int. Cl. B32B 9/04

(52) U.S. Cl. 428/411.1; 428/500

(57) ABSTRACT

A film laminate with at least one diffusion-barrier layer for production of a vacuum insulation panel, which can be used in the construction sector, has on at least one surface a heat-sealable polyolefin layer. Within this layer or on an external individual film or within a co-extruded composite that comprises at least externally a polyolefin layer, the polyolefin is provided with an effective amount of a flame retardant or of a mixture of flame retardants. This film laminate permits production of vacuum insulation panels which can be used in the construction sector, because when tested to DIN 4102-1 they meet the specifications for construction class B2.

### CROSS-REFERENCE TO RELATED PATENT APPLICATIONS

The right of foreign priority is claimed under 35 U.S.C. § 119(a) based on Federal Republic of Germany Application No. 10 2004 028 756.2, filed June 16, 2004, the entire contents of which, including the specification, drawings, claims and abstract, are incorporated herein by reference.

### BACKGROUND OF THE INVENTION

The invention relates to a film laminate with at least one diffusion-barrier layer for production of a vacuum insulation panel which can be used in the construction sector.

Film laminates with diffusion-barrier layers or film composites with diffusion-barrier layers are used for various purposes. “High-barrier” films with particularly high resistance to gas diffusion are needed, inter alia, for production of vacuum insulation panels.

Vacuum insulation panels are sheets in which insulating materials or inert fillers are completely encapsulated and the envelope, which has maximum impermeability to gases, is very substantially evacuated. Very low gas diffusion values are needed for the envelope material so that once the vacuum has been applied it is retained for the maximum time (at least from 10 to 15 years being desirable).

The extent of the vacuum depends on the insulating material used or the filler used and on the insulation effect expected from the panel. The expected level of impermeability of the envelope to gases is likewise dependent on the intended use. In the case of vacuum insulation panels (VIPs) intended for use in consumer goods which do not have very great lifetimes, e.g., camping refrigerators, cooler boxes and the like, the requirements are less stringent than for a panel intended for the construction sector and requiring maximum retention of the vacuum in order not to require replacement during the lifetime of a house.

Initially, aluminum foils were used for the envelope material of VIPs having very high impermeability to gases. However, a disadvantage of the metallic envelope was that there were heat bridges at the panel edges, and these reduced total insulation effect.

Nowadays, vacuum insulation panels (VIPs) use what are known as high-barrier films, these often being film laminates having from 3 to 5 layers, of which individual layers, mainly internal layers, have generally been metallized, i.e., have a vapor-deposited coating of a metal, such as aluminum, or have been provided with a highly gas-impermeable coating composed of, for example, silicon oxide (SiOx) or of metal oxides of the 2nd or 3rd main group of the Periodic Table. The main metal oxides which can be used for a (vapor-deposited) coating are magnesium oxide, aluminum oxide, calcium oxide, and beryllium oxide.

By way of example, DE 100 25 305 A1 (=U.S. 2001/0049014) or DE 100 47 043 A1 (=U.S. Pat. No. 6,740,394) disclose film laminates with a high level of gas-barrier effect. Although the high-barrier layers described therein have a good impermeability to gases and can hold the vacuum in VIPs for a long time, they are unsuitable for use in the construction sector because they do not meet fire-protection specifications.

Panels used in construction have to meet at least the requirements of construction materials class B2. DIN 4102-1 (corresponding to ASTM D-2863) controls the test to determine whether construction materials comply with this class. Because the panel-filling material has the very small thermal conductivity desired for the application, and because evacuation also inhibits heat dissipation, there is insufficient dissipation of heat from the location of a fire and severe local overheating occurs with a high risk of fire.

The use of fire retardants or flame retardants in plastics is known in principle, and by way of example PVC windows, PVC floorcoverings and various packaging materials are provided with flame retardants. According to the producers of these films, polyethylene films comprising flame retardants would themselves indeed meet the fire-protection requirements for class B1. However, as the applicant has found, this does not apply when these films form an envelope around an insulation material, this fact being attributable to the local overheating described above. There is therefore an urgent need for films with high gas impermeability for the construction sector.

### SUMMARY OF THE INVENTION

An object underlying the invention is therefore to design a high-barrier film in such a way that a vacuum insulation panel manufactured therewith complies with the construction engineering specifications to DIN 4102-1 and the flame-retardancy requirements of construction materials class B2.

To achieve this object, the invention provides a film laminate with at least one diffusion-barrier layer and with, on at least one surface, a heat-sealable polyolefin layer which has been provided with an effective amount of a flame retardant or of a mixture of flame retardants, either within or on an external individual film or within a co-extruded composite comprising, at least externally, a polyolefin layer.

### DETAILED DESCRIPTION OF THE PREFERRED EMBODIMENTS

Surprisingly and specifically, it has been found that a vacuum insulation panel produced with this film and having, besides at least one, or preferably two or more, diffusion-barrier layers, at least on the external film surface, a heat-sealable polyolefin layer with a flame retardant, is sufficient to comply with fire specifications, permitting use in the construction sector. The flame retardant within or on the outer sealable layer provides adequate inhibition of ignition. The metallization which may be exposed or rendered accessible to thermal contact at the site of smoldering also distributes heat over the surface, thus markedly reducing the risk of fire.

Despite the added flame retardant, the sealable layers bond well to the inventive film during production of a vacuum insulation panel, and do not impair the vacuum-tight nature of the material. Impermeability to water vapor and to gases is retained.

If the intention is to produce the panel using a high-barrier film which is sealable on both sides, the fire retardant or flame retardant may be provided in or on both external sealable layers. If the fire retardant is applied only on one side, it would be advantageous to identify this side as the external side, for example, via printing or coloring.

There are no particular restrictions on the nature of the polyolefinic sealable layer. Use may be made of any of the heat-sealable layers which are suitable and known for the purpose of heat-sealing. A heat-sealable polyethylene layer is currently preferred. Use may generally be made of polyolefin homo- or copolymers. Preference is given to linear low-density polyethylene (LLDPE), polybutylene (PB), ethylene-vinyl acetate (EVA), polypropylene (PP), high-density polyethylene (HDPE), ionomers (IO) and mixtures of these substances. The thickness of the sealable layers used in the invention is from 20 to 100 μm, preferably from 30 to 60 μm.

The flame retardant used in one preferred embodiment comprises antimony trioxide (SbO₃), individually or in combination with organohalogen compounds.

The flame retardants added may generally comprise flame retardants known to the person skilled in the art and suitable for use in plastics. It is preferable to use flame retardants from the following group, individually or in combination:

antimony trioxide, borates, in particular alkali metal borates, zinc borates, borax decahydrate, borax pentahydrate and/or melamine borate, ammonium phosphate, alkali metal silicates, aluminum oxide hydrates, alumina trihydrate, halogenated organic compounds, in particular chloroparaffins, hexabromobenzene, polybrominated diphenyl ethers (PBDEs), polybrominated biphenyls (PBBs), tetrabromobisphenol A (TBBA), tetrabromophthalic anhydride, dibromoneopentyl glycol, tris(2,3-dibromopropyl) phosphate (TRISBP), and/or tris (2-bromo-4-methylphenyl) phosphate, organophosphates, -phosphites, and -phosphonates, in particular tricresyl phosphate, tris(aziridinyl) phosphate (TEPA), and/or phosphoric esters.

Other fire retardants and flame retardants suitable for the purposes of the invention and known to the person skilled in the art can be selected if required or desired.

This flame retardant or fire retardant may be present in uniform and fine dispersion in the sealable layer and may have been introduced in any suitable manner into the sealable layer, e.g., during or after the polymerization process in the form of additives, dispersed in pulverulent form, or in solution, or in the form of “incorporated” reactive flame retardant during the polymerization process. The flame retardant may also be present within only one layer of a, for example, co-extruded composite of a sealable film. A single- or multilayer sealable polyolefin film of this type provided with a flame retardant may then have been bonded via lamination to one or more diffusion-barrier layers, e.g., metallized films.

It is also possible to use two or more flame retardants in combination, in which case, in order to ensure that the sealable layer is functional, the total amount should preferably not be greater than 50% by weight, more preferably not greater than 30% by weight, based on the polyolefin composition in which the flame retardant has been dispersed. An effective flame retarding amount of the flame retardant composition is that amount that provides compliance with the applicable testing standards for a given product, e.g., DIN 4102-1 (corresponding to ASTM D-2863). The amount of the flame retardant needed for effectiveness and to comply with fire-protection requirements can be determined experimentally by the person skilled in the art; in each case, the values depend on the nature of the flame retardant. The amount preferably present in the film composite, based on the polyolefin composition in which the flame retardant has been dispersed, is from 0.1 to 30% by weight, more preferably from 0.1 to 10% by weight, more preferably below 5% by weight, more preferably from 1 to 3% by weight.

As an alternative, the flame retardants or the mixtures thereof may also be applied from the solution to the surface of the sealable layer. The ratio between the weight of the coating and the weight of the sealable layer in percent by weight should likewise be as stated above.

The diffusion-barrier layers used in the high-barrier film laminate of the invention may comprise any of the layer combinations and layers customary for this purpose. Suitable layer combinations are found, inter alia, in DE 100 25 305 A1 (=U.S. 2001/0049014) or DE 100 47 043 A1 (=U.S. Pat. No. 6,740,394), the entire disclosures of which are hereby incorporated by reference. Preference is given to use of films composed of polyester, of polyamide, or of polypropylene and coated on one side or on both sides, and used individually or in a very wide variety of combinations. The coating is generally a vapor-deposited coating. The diffusion-inhibiting (vapor-deposited) coatings used are mainly metallization, preferably with aluminum, or coatings composed of silicon oxide (SiOx), or of a metal oxide of the 2nd or 3rd main group. The customary thickness of metallized films composed of polyester or of polyamide is, by way of example, around 12 μm, and that of metallized polypropylene films is around 18 μm.

The high-barrier films or film laminates comprising diffusion-barrier layers encompass individual films and/or co-extruded composite films bonded together via lamination. The film composites may also comprise co-extruded layers which have undergone a vapor-deposition process and which themselves comprise at least one sublayer of a gas-diffusion-barrier layer, preferably composed of polyvinyl alcohol, or composed of ethylene-vinyl alcohol copolymer (EVOH).

The vapor-deposition thickness of the diffusion-barrier layers is preferably from about 30 to 100 nm.

Suitable layer structures are mentioned in the examples.

Another embodiment of the invention provides that the sealable layer(s) has/have been equipped with an additional barrier layer in order further to increase the barrier effect of the laminate. This additional barrier layer integrated into the sealable layer may be a layer composed of polyvinyl alcohol, or composed of ethylene-vinyl alcohol copolymer (EVOH).

One possible layer structure for this “sealable layer with barrier layer” (PEX) would be:

PE/AP/barrier/AP/PE

Key: barrier=EVOH, AP=adhesion promoter and

PE=heat-sealable polyethylene layer.

The barrier layer is generally linked to the polyolefin layer, in the example a polyethylene layer, by way of a customary adhesion promoter familiar for this purpose to the person skilled in the art. The integrated sealable barrier layer (PEX) may be produced via co-extrusion of the individual layers.

Film laminates equipped with an additional barrier layer in the sealable layer are given in the examples.

Use of the sealable layer with barrier function (PEX) within the inventive film laminate can further increase the barrier effect, i.e., impermeability to gases and to vapors.

Whereas oxygen-diffusion values at least smaller than 0.01 cm³/m² d bar (23° C., 75% relative humidity) and water-vapor diffusion values at least smaller than 0.1 g/m² d (38 ° C., 90% rel. hum.) are achieved in known high-barrier films, these values can be further reduced, approximately by half, via introduction of a sealable barrier layer (PEX).

The invention also encompasses the use of the film laminates described in more detail above for production of a vacuum insulation panel for the construction sector, and a vacuum insulation panel thus produced, in which an inert filler or an insulating material has been enclosed by a substantially gas-tight envelope composed of a film laminate of the invention, and the enclosed space has been substantially evacuated. The shape of the panel is preferably that of a sheet, which has been cut out of the insulating material or has been compression molded from a pulverulent filler. The sheet is enclosed by the inventive film laminate in such a way as to provide the flame retardant at least in or on the outer layer, which is a heat-sealable layer and is furthest from the insulating material.

### EXAMPLES

The following possible layer structures for film laminates of the invention are given without restricting the general applicability of the invention

Inventive example 1: PM/MPP/MP/PE; single-side-sealable film laminate, layer thicknesses (in μm): 12/18/12/60

Inventive example 2a: PE/PM/MPP/MP/PE; thickness (in μm): 60/12/18/12/60 (layers without flame retardant) water-vapor permeability =WVP (38° C., 90% rel. hum.)<0.05 g/m² d

O₂ permeability=O₂P (23° C., 75% rel. hum.)<0.01 cm³/m²·d·bar)

Inventive example 2b: PE/PM/MPP/MP/PE; thickness (in μm): 60/12/18/12/60; (PE in each case with flame retardant) water-vapor permeability=WVP (38° C., 90% rel. hum.)<0.05 g/(m²d), O₂ permeability=O₂P: <0.01 cm³/m²·d·bar) (23° C., 75% rel. hum.)

where:

PE=heat-sealable polyethylene layer

PM or MP=metallized polyester film (the sequence of the letters indicates the position of the metallization in the layer structure)

MPP=metallized polypropylene film

/=layer sequence, position of lamination between layers

The abovementioned layer structures are merely non-restricting examples and, by way of example, it is also possible, as described in DE 100 47 043, for another barrier layer composed of polyvinyl alcohol, ethylene-vinyl alcohol copolymer, or polyethylene to be present in the interior of the layer structure.

Film laminates with sealable barrier layers for a further increase in barrier effect can, by way of example, have the following layer structure:

Inventive example 3: PM/MPP/MP/PEX, single-side-sealable film laminate, layer thicknesses (in μm): 12/18/12/50

Inventive example 4: PEX/PPM/MPP/MPP/PEX; thickness (in μm): 50/18/18/18/50; (PE with EVOH)

WVP (38° C., 90% rel. hum.)<0.03 g/(m²d), O₂P: <0.01 cm³/(m²·d·bar)(23° C., 75% rel. hum.)

PEX=PE/AP/EVOH/AP/PE;

PM or MP=metallized polyester film (the sequence of the letters indicating the position of the metallization in the layer structure)

PPM or MPP=metallized polypropylene film (the sequence of the letters indicating the position of the metallization in the layer structure)

/=layer sequence, position of lamination between layers

Testing of fire performance

A vacuum insulation panel sheet having fumed silica as filler and enclosed with the inventive film laminate of example 2b (panel thickness: about 20 mm) was evacuated and tested to DIN 4102-1, May 1998, construction materials class B2, section 6.2.5, applying a flame to the edge in accordance with Section 6.2.5.2 and to the frontal edge of the specimen according to Section 6.2.5.5. Two different test procedures were used here to apply flame to the solid edges of the vacuum thermal insulation sheet (without taking into account the welded-seam strips) and to the various fixed welded seams of the vacuum thermal insulation sheet. After completion of the tests and evaluation of the results, the testing institute judged that the insulating material has normal flammability to DIN 4102-B2, the relevant test certificates being H.2-054/04 and H.4-055/04. The thermal insulation product tested complies with the requirements for construction materials class DIN 4102-B2.

Comparative test: The requirements are not met by a vacuum insulation panel enclosed for test purposes with PE film (corresponding to DIN 4102, UL 94 and LOI (ASTM D2863)) with flame retardant.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

1. A film laminate for production of a vacuum insulation panel which can be used in the construction sector, comprising:
at least one diffusion-barrier layer; and a heat-sealable polyolefin layer on at least one surface of the film laminate, the heat-sealable polyolefin layer being positioned within or on an external individual film or within a co-extruded composite film that at least externally comprises a polyolefin layer, wherein the polyolefin layer comprises a flame-retarding amount of a flame retardant or of a mixture of flame retardants.

2. The film laminate as claimed in claim 1, wherein the sealable layer comprises a heat-sealable polyethylene layer.

3. The film laminate as claimed in claim 2, wherein the heat-sealable polyethylene layer is on both sides of the film laminate.

4. The film laminate as claimed in claim 1, wherein the flame retardant comprises an agent selected from antimony trioxide, a borate, ammonium phosphate, an alkali metal silicate, an aluminum oxide hydrate, a halogenated organic compound, an organophosphate, an organophosphite, an organophosphonate, a phosphoric ester and a combination thereof.

5. The film laminate as claimed in claim 4, wherein the flame retardant comprises a borate selected from an alkali metal borate, zinc borates, borax decahydrate, borax pentahydrate, melamine borate and a combination thereof.

6. The film laminate as claimed in claim 4, wherein the flame retardant comprises a halogenated organic compound selected from a chloroparaffin, hexabromobenzene, a polybrominated diphenyl ether (PBDE), a polybrominated biphenyl (PBB), tetrabromobisphenol A (TBBA), tetrabromophthalic anhydride, dibromoneopentyl glycol, tris(2,3-dibromopropyl) phosphate (TRISBP), tris(2-bromo-4-methylphenyl) phosphate and a mixture thereof.

7. The film laminate as claimed in claim 4, wherein the flame retardant comprises an organophosphate selected from tricresyl phosphate, tris(aziridinyl) phosphate (TEPA) and a mixture thereof.

8. The film laminate as claimed in claim 4, wherein the flame retardant comprises alumina trihydrate.

9. The film laminate as claimed in claim 1, wherein the amount of the flame retardant present is from 0.1 to 30% by weight, based on the polyolefin composition in which the flame retardant has been dispersed.

10. The film laminate as claimed in claim 9, wherein the amount of the flame retardant present is from 0.1 to 10% by weight.

11. The film laminate as claimed in claim 10, wherein the amount of the flame retardant present is from 1 to 3% by weight.

12. The film laminate as claimed in claim 1, wherein the diffusion barrier layer comprises at least one film selected from the group consisting of a polypropylene film, a polyamide film, and a polyester film, which has been metallized or has been subjected to a vapor-deposition process using SiOx or using a metal oxide of the 2nd or 3rd main group of the Periodic Table.

13. The film laminate as claimed in claim 1, which is comprised of individual layers that have been bonded via lamination.

14. The film laminate as claimed in claim 13, wherein at least one of the individual layers comprises a co-extruded composite layer.

15. The film laminate as claimed in claim 1, wherein the diffusion-barrier layer comprises a layer which has been subjected to vapor deposition on one or both sides.

16. The film laminate as claimed in claim 1, wherein at least one diffusion-barrier layer comprises a co-extruded layer which has been subjected to a vapor-deposition process and which comprises at least one sublayer of a gas-diffusion-barrier layer.

17. The film laminate as claimed in claim 16, wherein the gas-diffusion-barrier layer comprises polyvinyl alcohol or an ethylene-vinyl alcohol copolymer (EVOH).

18. The film laminate as claimed in claim 1, wherein at least one of the polyolefinic sealable layers comprises a co-extruded gas-diffusion-barrier layer, comprising polyvinyl alcohol or an ethylene-vinyl alcohol copolymer (EVOH).

19. The film laminate as claimed in claim 1, wherein the diffusion-barrier layer is metallized and the vapor-deposition thickness of the metallized diffusion-barrier layer is from 30 to 100 nm.

20. A vacuum insulation panel for the construction sector, comprising an inert filler that is completely enclosed by a substantially gas-tight envelope, wherein the enclosed space has been substantially evacuated of gases, and wherein the gas-tight envelope comprises a film laminate as claimed in claim 1.
